(19) United States
(12) Patent Application Publication
(10) Pub. No.: US 2010/0096219 A1
(43) Pub. Date: Apr. 22, 2010

(54) Engines which work using gravitational force

(76) Inventor: Khalilulla A. Khasyanov, Brooklyn, NY (US)

Correspondence Address: KHALILULLA A. KHASYANOV, 3070 Brighton 1st Street, P.O. Box # 35, Brooklyn, NY, 11235, US

(21) Appl. No.: 12/289,163

(22) Filed: Oct. 22, 2008

(51) Int. Cl. F03G 3/00; F03G 7/10

(52) U.S. Cl. 185/27; 74/DIG. 9

(57) ABSTRACT

1. The engine works using gravitation force

2. The engine consists of parts that rotate and do not rotate, and comprises from at least one rotor and stator.

3. The engine consists of traveling weights on at least one rotor disk, displacing gravity center and creating rotation of the rotor. This way engine works.

4. The engine can work in liquid if conditions meet engine operation.

5. The engine can work due to buoyancy force, which occurs with help of gravitation force in liquid.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application relates to engines, which perform useful work and which do not use external energy

2. Prior Art

The advantage of my invention is that it gives the cheapest energy in the world. This invention is ecologically clean. It can work both in a stationary and a mobile versions. It can be used as modules, like batteries, and perform the same functions. This invention may work like a regular engine. It can produce constant and alternative voltages rotating existing generators.

The invention works using permanent forces of nature. As an example of such forces are magnetic forces. I use the gravitation force in my invention. It is practically inexhaustible. Therefore my invention can produce inexhaustible quantity of electrical power together with existing generators, like hydropower plants.

It is not required to use permanent forces for the engine, to buy, they exist independently, and because the engine does not require maintenance and financial expenses like other aggregates do. I used forces that originally act in nature, therefore my invention is advantageous, because it changes nothing and does affect ecology. It is an ecologically clean source. The advantage of my invention is its distinction from others ones.

Atomic energy is a very dangerous energy and expensive in maintenance. My invention is not dangerous and harmful therefore it is advantageous. Furthermore my invention can produce mechanical energy, e.g. to rotate a fan.

The maintenance of power plants energy is expensive and harmful for environment.

Atomic power plants require electric supply lines, which are very expensive. My invention is advantageous because does not require power supply lines, it is cheap in maintenance and ecologically clean.

Solar batteries require large areas and work well only in daylight. My aggregate is more advantageous because does not require large areas, and can work 24 hours a day.

Wind energy is low efficient and depends on a wind, uses accumulators sometimes. All these factors affect ecology. My aggregate is more advantageous because does not affect ecology and more efficient because does not depend on a wind.

Thermal power plants require too many expenses, their maintenance is very costly, and they contribute to ecological pollution. My aggregates are ecologically clean, and do not require power supply lines like hydropower plants. My invention has a number of advantages in comparison with existing ones because it gives inexhaustible electrical or mechanical power. It can work directly for consumers, above water, under water, above ground, under ground, everywhere where there are gravitation forces, and where conditions meet the engine operation. Obstacles to a water flow in hydropower plans and to a wind in wind sources change the temperature of environment and as a result harms ecology. My invention does not have the above shortcomings. The design of my invention is much simpler than some of the above mentioned, and does not require large expenses and time for its production, which makes it even more advantageous.

My invention in conjunction with existing generators can be used for electrical power consumers, providing it to them and also for mechanical power consumers if such power satisfy them. It can be a large variety of consumers. That is why this invention is unique and is very-very necessary for humanity. The invention of the engine, one of the most valuable for humanity, it deserves.

### DRAWINGS

### Figures

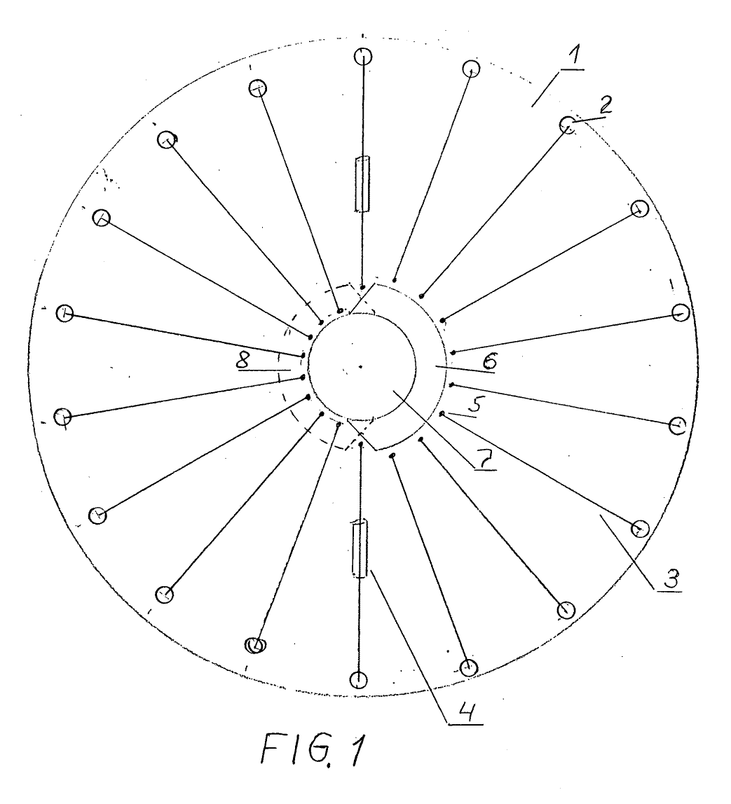

FIG. 1 shows the rotor disk

1 Rotor disk

2 Weight

3 Rod

4 Guides

5 Rod wheel

6 First limiter

7 Stator

8 Second limiter

FIG. 2 shows the engine1 Rotor disk

2 Guides

3 Rod

6 Magnet

7 Wheel

8 Guides

9 Rod

10 Weight

11 Weight

12 Rotor disk bearing

13 Bar bearing

14 Bar

15 Bar

16 Bar bearing

17 Wheel axle

18 Rotor disk mounting

19 Magnet

20 Magnet

21 Wheel

22 Wheel

23 Weight

24 Weight

25 Second rotor disk

26 First limiter

27 Second limiter

28 First stator magnet

29 Second stator magnet

30 First limiter

31 Second limiter

32 Bar

33 Bar

34 Bar

35 Stator

36 Body

37 Base

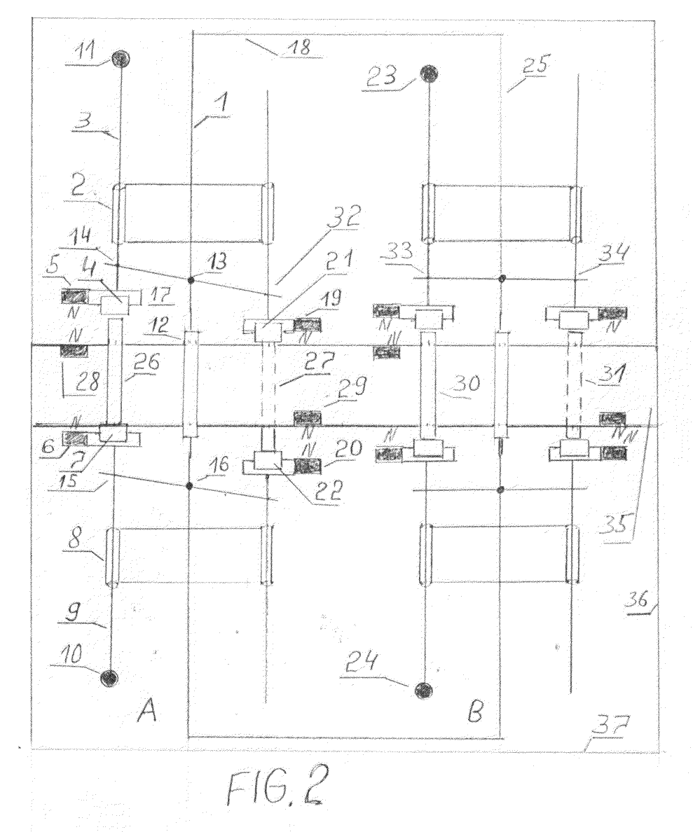

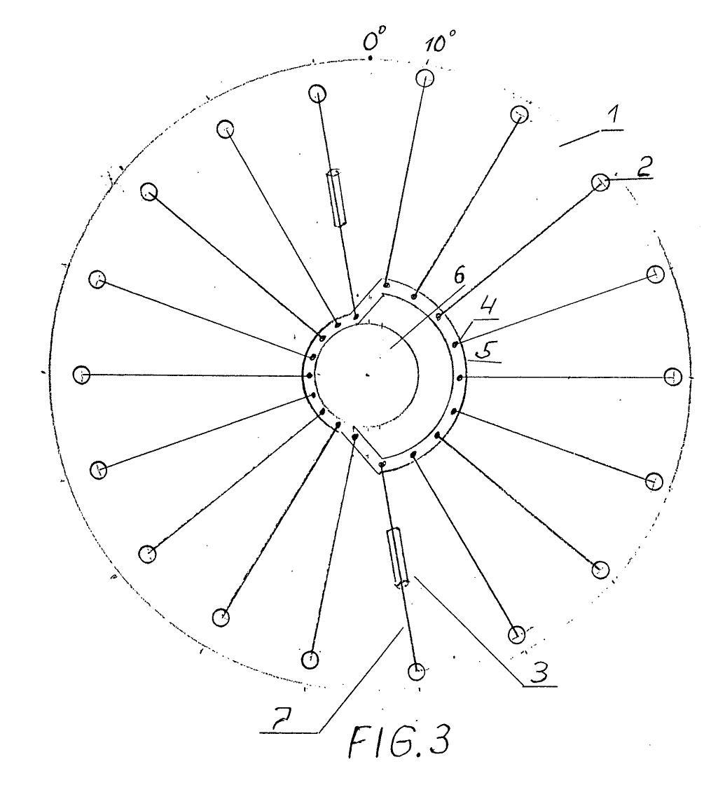

FIG. 3 shows rotor disk

1 Rotor disk

2 Weight

3 Guides

4 Rod wheel

5 Limiter

6 Stator

7 Rod

FIG. 4 shows leverage, example

1, 2, 3 dimensions in inches

2 m two mass units

4 m four mass units

A, B, C distance points

O central point

### DESCRIPTION

The engine consists of the stator 7 (see FIG. 1), rotor disk 1, weight 2, rods 3, guides 4, rod wheels 5, limiters 6 and 8, stator 7.

The engine works using center gravity displacement. FIG. 1 shows, that stator 7 and limiters 6 and 8 are stationary. There are 8 rods with weights on the right side and they located farther from the stator center. The rods from left side are located closer to the center. Two rods with weights are vertical. As the right side with rods and weights is the same as the left side, but rods with weights of the right side are farther from the center than the ones of the left side, the disk begin to turn clockwise, at the same time lifting rods with weights.

The weights of the right side of the disk are forced to go down by the gravitation force, while weights of the left side of the disk go up by the displacement of disk gravity center. Rods and weights of the right side lift vertical rods by means of limiters 6 and 8, and rod wheels 5. During rotating of the rotor disk, vertical rods with weight are lifted alternatively—first pair, then second, then third, etc.

Quantity of rods and weights from left and right side remains constant. But weights from left side are closer to the rotor center, and weights of the right side are farther from the rotor center. Weights of the rotor displace the disk gravity center, the disk rotates, lifting vertical rods with weights, the latter, while lifting, keep the quantity of left and right weights and also the displacement value unchangeable. This displacement and the gravitation force rotate the rotor. This way the rotor rotates.

FIG. 4 shows example of leverage work. There is a lever on a rest point O. The weight of four unit mass is on the right side of the lever at the distance of three inches from point O. There are another two weights on the left side of the lever—of two and four unit masses at distances two and one inches from point O correspondently. The point B of the right side of the lever moves down, while lifting the weights of the left side in points A and C. This example proves that rotor disk will rotate. Presuming, that point A is the left side of the disk, point B is the right side of the disk, point O is the stator center, point C is a vertical rod with weight—this proves the engine working.

FIG. 2 shows the engine with two rotor disks and the stator. Second disk rotor is designed to accommodate more weights into left and right sides of the disks. The disk on FIG. 1 has as many weights as the disk on FIG. 3, but the latter has the displacement of the weights by 10 degrees clockwise. Thus, FIG. 1 shows, that the weights of disk 1 on and weights of disk 25 are set every other one, and there are 16 weights in the right sides of the disks as well as in the left sides. Consequently, increasing the number of disks, the number of weights will be increased. Due to the increase, it will be easier to lift vertical weights with rods.

To lift vertical weights easier, magnets are used in the engine (see FIG. 2). Repelling one another, the magnets help to lift weights.

FIG. 2 shows guides 2 on the left side of disk 1. Rod 3 with weight 11 travels in guides 2. Wheel 4 and magnet 5 are located on rod 3. Wheel secured on axle 17, which is mounted on rod 3.

There is limiter 26 on stator 35. Wheels 4 and 7 slide over limiter 26. Wheel 7 is closer to the rotor center than wheel 4. Magnet 28 on stator 35 lifted magnet 5. It is a vertical rod that is lifted onto limiter. Bar 14 of disk 1 travels up and down together with rod 3, and is secured on disk 1 via bearing 13. Second end of bar 32 on the right side of disk 1 travels with rod, wheel 21 and magnet 19. Rod on the right side does not have a weight and lighter then left side by mass of weight 11. If right wheel 21 travels down, then left wheels travels up. Wheel 22 (in the right lower part of disk 1) travels down, magnet 29 repels magnet 20 and moves over stator limiter 27, Wheel goes. Bar 15 lifts rod 9, which travels along guide 8. Wheel 7 moves onto limiter 26, weight 10 is lifted up. Thus all the rotor disks weights travels up and down, creating displacement of the gravity center, which in its turn revolves the rotor. Second rotor disk 25 works similarly to disk 1 but weights with parts are displaced by 10 degrees clockwise.

Letters A and B on FIG. 2 designate left and right portion of the engine. The engine body can be of any shape. Base 37 is the bottom of the engine. During the engine operation, engine stator is to be located horizontally, while rotor disks—horizontally. Disks 1 and 25 are secured with bolts 18. All the magnets must interact with each other by similar poles. Letter N on magnet denotes the north pole of the magnet.

FIG. 1 shows approximate layout of limiters on stator, weights on disk, and wheels on limiters. Thus, the engine works lifting consecutively pairs of vertical weights, creating displacement of gravity center. Initially the displaced gravity center of the rotor disks turns them clockwise using the gravitation force. Revolving pairs of vertical weights are being consecutively lifted, keeping weight displacement constant, that in its turn keeps rotor continuously revolving. Rotor is comprised from a disk or several disks bolted together and mounted onto bearings in stator. This way the engine works.

The similar magnetic poles are used in the engine, but it is possible to use poles that attracts too or combination of magnets that repel and attract. It is important that magnets help lift pairs of vertical rods with weights. It is possible not to use magnets at all. FIG. 3 shows the work of such engine. Stationary stator 6 is in the center. Limiter 5 is secured on stator 6 and made in shape of a curved pass limiting movement of wheels 4, creating trajectory for wheels 5 and rods 7. Rods travel over guides 3. Weights 2 are located on rods. All of them are on disk 1 except stator and limiter.

Whereas engine is working, stator has to be in horizontal position and rotor disks in vertical position. Rotor is mounted onto bearings in stator in a way the described above engine is done. Stator mounting on the body is done similarly to the engine on FIG. 2. Wheels of rods 4 travel as disks rotate along trajectory set by disk limiters.

Example of leverage on FIG. 4 proves the working of the given engine. It is possible to connect load to the engine through a belt drive or through any existing method.

Weights in the engines are at the same distance between them if they are at least on the same disk. The engine can be stopped by any existing method. To connect the engine and a load it is possible to use any existing method, e.g. through clutches, belt drives, etc.

The engine can work in a liquid, if conditions meet performance of the engine.

The engine can work by way of buoyancy force with help of the gravity force in liquid, where the engine is, if mass of each weight is less than weight of the same volume of liquid, and if conditions meet performance of the engine.

If the engine works in liquid by way of buoyancy force with help of magnetic forces, it is necessary to turn the base of the engine up, and make mass of each weight less.

Bearings must be waterproof.

As the friction force in the engine FIG. 3 and resistance of magnetic forces in the engine FIG. 2 may result in the engine standstill, let us do the following: add some parts to the engine, which will revolve the rotor despite of any mentioned above resistances inside the engine.

In the engine on FIG. 2, Let us install magnets 38, 39, 40, 41 the way they would attract rod magnets 52, 55, 6, 19, and other rods alternatively or by another method. Small cones are installed on rods and rotated on axle. The axle is mounted onto rod through bushings or bearings. Large cones are also installed on rods and rotated on axles mounted onto rod through bushings or bearings.

Large cones are designated on FIG. 2 as letter U, small cones are designated as 59, 61, 63, 65. Limiters 58,60,62, 64 are secured on uprights 42, 43, 44, and 45. There are also parts 66, 67, 68, 69 mounted on the uprights. Large cone of the rods travels onto these parts. The uprights are bolted to stator 35.

Counterweights 46, 47, 48, 49 are set on the axle of wheels located on the right side of discs or on the rods without weights. The weight of these counterweights is equal to the weight of large and small cones together with their axles and bearings or bushings.

Here is the description of engine FIG. 2 operation with the parts installed on it.

FIG. 7 shows the large cone traveling along trajectory BD of parts 66, 67, 68, and 69 of FIG. 2. Point U (FIG. 7) of large cone moves from point B down, at the same time point U moves away to the right from point A at a distance, at base CD, cone radius plus the distance from point C to D. FIG. 8 and FIG. 9 show touch points of cone with segment BD FIG. 7.

The large cone and FIG. 7 are needed for point U to move away from point B as much as possible, while cone travels up and down, do not creating big resistance to rod movement. FIG. 6 shows large cone 1 movement upwards along side BD of part 2.

On FIG. 2 disks 1 and 25 are secured on the same shaft, and mounting 18 is removed. Uprights 42, 43, 44, 45 are bolted to stator 35 and body 36 as it shown on FIG. 5. Guides 2 (FIG. 2) are replaced with guides 6 and 7 (FIG. 5). Uprights 2 on FIG. 5 can be in a shape of disks or in any other shape. They secure stator to body, and hold parts, which secured on them. Guides 6 and 7 are needed for rod traveling. Weight 8 is mounted on rod 1. Large cone 10 and small cone 4 are secured through bushings or bearings 9 and 5. Rod 1 has facets, so it cannot be rotated. Rod 1 is mounted to disk by guides as it shown on FIG. 5. Disk 12, as well as other disks, is mounted on shaft 14. Shaft 14 is mounted on stator 16 through bearings 15. Upright 2 is mounted to body 13 and stator 16. Large cone 10 travels along side BD of the part 11, which is secured to upright 2. Limiter 3, restricting movement of small cone upwards, is also secured to upright 2. Limiter 3 is made in such way that small cone 4 could move upwards simultaneously with point U of large cone passed after point B of part 11 FIG. 5.

On FIG. 5 is shown with arrows movements of rod and disk 12. Limiter 3 FIGS. 5 and 20 FIG. 11 must be located as closer as possible to the rotor shaft center, for better engine operation.

FIG. 6 shows stator 33, hole 13 for rotor shaft. It is shown layout and shape of magnets of stator 11 with pole N outside and magnet 12 with pole S outside or in outside diameter. Magnets 16 and 18 on FIG. 6 move onto magnet 11 and do not repel because they are held by bars and limiters from other side of the disk.

See FIG. 2 bar 33 limiter 31 magnet 51. As soon as limiter ends, rod is held due to or on limiter of small cone MP FIG. 6. When point U of large cone passes beyond point B of part 2, limiter MP lowers small cone and rod moves upwards because rod magnet 14 repels stator magnet 11. Large cone travels along BD of part 2 and turns disk. Another side of disk restricts upward movement of magnet 28 through bar. See FIG. 2 magnet 5 and 19 bar 14. On the left side of disk 1, magnet 5 repels magnet 28 and on the right side of disk 1, magnet 19 attracts magnet 40. Magnets move simultaneously due to bar 14 and 32. At the same time other magnets of rods FIG. 6 magnet 18 goes onto stator magnet 11, and rod magnet 25 moves away from stator magnet 12.

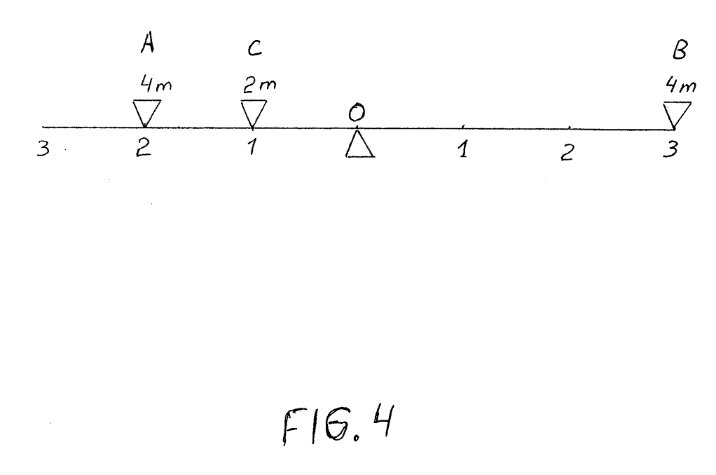

FIG. 10 shows lower vertical rod. If we look at FIG. 2, we will see that magnet 54 is repelled by stator magnet 53, and translates the motion through bar to magnet 55. Magnet 55 in its turn is attracted to stator magnet 39, and rod 57 moves at first along limiter 30, then when rod with its small cone 61 moves along limiter 60 reaching to point B with point U of a big cone, point B of part 69, limiter 60 releases small cone 61 and rod is moved upwards by magnet 55.

Large cone moves along side BD and turns rotor disk, while setting other rod magnets on to stator magnets, at breaking off other rod magnets from stator magnets from another side.

On FIG. 10 limiter LM releases small cone 4. Point U of large cone moves upward. Large cone moves along side BD of part 1. Magnet 6 is attracted to magnet 12. Rotor disk turns, setting other rod magnets from ones stator magnets to another. Rods travel along guides 3 and 5 FIG. 10. On FIG. 6 upper vertical rod has passed limiter MP, and is moving clockwise. Wheel of magnet 28 starts to move in point E onto limiter 31. After that magnet 11 stops to hold it.

FIG. 6 shows trajectory 30 of point U of large cone from left to right. Movement from right to left of small cone is shown with dashed line KL in the bottom.

FIG. 6 shows parts 1 and 2, which are used to help the engine overcome magnetic friction forces.

If several disks install on the same shaft, and their rods are displaced consecutively, that is rods of one disk are displaced clockwise relatively to rods of another. Let us assume, that first disk rods begin from 0 degrees and set apart every 15 degrees. Second disk rods begin from 3 degrees, and also set apart every 15 degrees. Then from 6, 9, 12 degrees, etc. Thus two or one rods will be lifted at every 3 degrees, if limiters are set correspondently.

If all or two rods with weights are alternatively lifted, then half of all rods with weights except two or one rod with weight will create rotation of the rotor due to displacement gravity center and gravitation force, as well as with help of magnetic forces.

At the same time the quantity of vertical rods with weights, which simultaneously are lifted, can be either, corresponding engine operation.

Let us assume that on FIG. 3 there are 10 rods with weights on the left and on the right side from vertical rods. There are 24 rods with weights on one disk then there will be 100 rods with weights on 5 disks. Two rod of them, let us say, are on the rise. One from the top, another from the bottom of the shaft center. Other 88 weights are displaced from the center, say, for example, by 1 inch. 49 weights are closer to the center, another 49 farther from the center. This constant displacement proves the capability of rotor to rotate. That is 49 force units act from the right, turning disks. If magnets are located vertically and face each other with the same poles, then lower magnet can lift upper one. This proves that rods will lift weight using force of their magnets. The weight is to be such that magnet could lift it and move disk by movement of large cone along side BD.

FIG. 6 shows, that the distance from center stator magnets is 3 times less than the distance from the center to point B, therefore the force of magnet 14 repels magnet 11 and attracts another side of bar. See on FIG. 2 repelling force of magnets 50 and 51 plus attraction force of magnets 52 and 38, they act together due to bars 34 and 33. Let us get back to FIG. 6. The repelling force plus attraction force of vertical rod magnets minus force for weight lifting is a force multiplied by 3, the force, which moves large cone. This force plus gravitation forces of all weights displaced from center will be enough to break off attracting magnets and set them on repelling ones. Two magnets acting through bar on the top and two magnets acting through bar in the bottom can lift rods simultaneously from top and bottom, and can alternatively, if limiters are displaced from top and bottom. It is possible to move stator magnets FIG. 2. Assume, at first magnet 5 is repelled, then magnet 19 will be attracted. Then magnet 20 is repelled, and magnet 6 is attracted. It will be easier alternatively break off attracted magnets and set them on repelling ones. On FIG. 6 it is enough to move magnet 11 by 1/16 inch to the right counterclockwise. And magnet 12 too. Thus the engine works using gravitation force and with help of magnetic force.

1. Let us remove magnets on FIG. 2, large and small cones with bearings or bushings. And if forces will be enough to rotate the disks, then engine rotor will be rotated. Thus the engine will be working.
2. If the engine works, then for its operation in liquid, it is needed to replace weights.

1. Use weights that are lighter then the liquid, volume of the weight must be lighter of the same liquid volume

2. Turn the engine with its base up. The engine will be working due to buoyancy force

3. On FIG. 2 let us try to remove only weights. And if 1. The force of one or several magnets will be enough to rotate the disk or disks. And if 2. Cone movement does not end along BD before another cone starts movement along BD of the part, then engine rotor will rotate and engine will work. It is necessary to make changes for engine working in liquid with buoyancy force in accordance to item 2.
4. On FIG. 2, FIG. 5, FIG. 11 the engine is shown, that will work without any if. Engine works with help of magnetic forces, when movement of large cone does not stop until movement of another cone along side BD. The engine works using gravitation force. As if one magnet set above another with the same pole, then magnet forces can not only lift magnet weight but also repel it with force. And so on FIG. 4 point B will go down, lifting weights C and A. This is a proof that engine on FIG. 2, FIG. 5, FIG. 11 will work. Sum of the displaced weight forces is much bigger then on FIG. 4 in point B. Weight in point C is lifted by magnets.

Mass of one weight and magnet force are to be such, that left and right disk magnets could lift a rod with help of bar. And sum of disk weight forces could rotate disk or disks, lifting as minimum alternatively, upper rod weight, then lower weight of lower rod and v. versa, using force, that large cone moves disk. One or several disks are rotated with displaced rods in a way, that weights would lift one after another alternatively with unchanged positions of stator magnets. Initially, stator magnets positioned so as at first they lift upper rod, then lower rod or v. versa.

It is desirable that rod magnets would be arranged along rod wheel axle or along shaft. Large and small cones must be installed on every engine rod where magnets are.

Regarding part design of the engine, It is possible to make rotation clockwise or counter clockwise.

It is better to do so (FIG. 2) that rod magnet with opposite pole moves from stator upper magnet, and then magnet comes with similar pole to stator magnet pole. In another words, if engine rotates clockwise, then large cone moving clockwise, breaks off rod magnet attracted to stator magnet. For example, if mass of weight can bring closer magnets of rotor and stator with similar poles to a distance of 1 inch, then the weight is to be divided in half and if stator magnet lift it by ¾ inch, then the weight then the weight and rod magnet can be used in the engine. Then several weights on disk rods displaced from disk center allow the engine to rotate. The displacement in the example is 1 inch. One stator magnet must lift weight at least by half of an inch, and two magnets—by 1 inch and moor.

I claim:

1. The engine consists of traveling weights located on at least one rotor disk, displacing gravity center and creating rotation of the rotor. This way the engine works.

2. The engine can work in liquid if conditions meet engine operation.

3. If the engine works in liquid due to buoyancy force, which occurs with help of gravitation force, using magnetic forces, it is peccary to turn the engine base up, and make the mass of every weight lighter then the same liquid volume that is volume of every weight. Bearings must be protected if necessary.

4. Rotor disks may be installed on the same shaft, and stators can be set in between disks, with holes in stator for rotor shaft. The engine can be of any design, corresponding to engine operation.

5. If the engine made in a way that weights are lifted alternatively by one, and then from the top, and v. versa, then for engine rotation is needed to lift at least one weight.

6. Engine operation is possible without gravitation force if
1. To make it without weight on rods
2. Movement of large cone of one rod along side BD does not end until beginning of the movement of another rod along side BD.
At the same time it is possible to change the engine design for better operation.
